(19) United States
(12) Patent Application Publication
(10) Pub. No.: US 2022/0002977 A1
(43) Pub. Date: Jan. 6, 2022

(54) SYSTEM AND METHOD FOR WORK MACHINE

(71) Applicant: KOMATSU LTD., Tokyo (JP)

(72) Inventors: Koichi NAKAZAWA, Tokyo (JP); Osamu YATSUDA, Tokyo (JP)

(21) Appl. No.: 17/289,383

(22) PCT Filed: Jan. 20, 2020
(86) PCT No.: PCT/JP2020/001775

§ 371 Date: Apr. 28, 2021

(30) Foreign Application Priority Data
Jan. 23, 2019 (JP) 2019-008903

(51) Int. Cl. E02F 9/26; B60R 11/04

(52) U.S. Cl. CPC E02F 9/261; B60R 11/04; E02F 9/264

(57) ABSTRACT

A system includes a processor and a display. A plurality of cameras capture images indicative of surroundings of a work machine. A processor acquires image data indicative of the images captured by the plurality of cameras. The processor acquires a traveling state of the work machine. The processor synthesizes the images and generates an image from a viewpoint corresponding to the traveling state. The display displays the image from the viewpoint corresponding to the traveling state based on a signal from the processor. The system may include the cameras and the work wachine.

### CROSS-REFERENCE TO RELATED APPLICATIONS

This application is a U.S. National stage application of International Application No. PCT/JP2020/001775, filed on Jan. 20, 2020. This U.S. National stage application claims priority under 35 U.S.C. § 119(a) to Japanese Patent Application No. 2019-008903, filed in Japan on Jan. 23, 2019, the entire contents of which are hereby incorporated herein by reference.

### BACKGROUND

### Field of the Invention

The present invention relates to a system and a method for a work machine.

### Background Information

A system which displays a work machine and an image indicating the surroundings of the work machine is known in the prior art. For example, in International Publication No. WO 2016-031009, a system includes a plurality of cameras attached to a work machine, and a controller. The plurality of cameras capture images of the work machine and the surroundings thereof. The controller synthesizes a bird's-eye view image from the images captured by the plurality of cameras.

### SUMMARY

As indicated above, the controller generates an image that indicates the work machine and the surroundings thereof by synthesizing the plurality of images captured by the cameras. Therefore, the controller is able to generate images from different viewpoints. A user may want to change to an image with a different viewpoint corresponding to the traveling state of the work machine. However, it is difficult to change the viewpoint while working when the viewpoint of an image is changed with a manual operation of the user. An object of the present disclosure is to allow a user to be able to easily use an image from a viewpoint corresponding to the traveling state of the work machine.

A system according to a first aspect includes a work machine, a plurality of cameras, a processor, and a display. The work machine includes a work implement. The plurality of cameras capture images indicative of surroundings of the work machine. The processor acquires image data which represents the images captured by the plurality of cameras. The processor acquires a traveling state of the work machine. The processor synthesizes the images and generates an image from a viewpoint corresponding to the traveling state. The display displays the image from the viewpoint corresponding to the traveling state based on a signal from the processor.

A method according to a second aspect is a method executed by a processor for displaying surroundings of a work machine including a work implement on a display. The method includes the following processes. A first process is capturing images indicative of the surroundings of the work machine with a plurality of cameras. A second process is acquiring image data which represents the images captured by the plurality of cameras. A third process is acquiring a traveling state of the work machine. A fourth process is synthesizing the images and generating an image from a viewpoint corresponding to the traveling state. A fifth process is displaying the image from the viewpoint corresponding to the traveling state on the display.

A system according to a third aspect t includes a processor and a display. The processor acquires image data. The image data represents images indicative of surroundings of a work machine. The processor acquires a traveling state of the work machine, synthesizes the images, and generates an image from a viewpoint corresponding to the traveling state. The display displays the image from a viewpoint corresponding to the traveling state based on a signal from the processor.

The traveling state of the work machine is acquired in the present disclosure. An image from a viewpoint corresponding to the traveling state is automatically displayed on the display. As a result, a user is able to easily use the image from a viewpoint corresponding to the traveling state of the work machine.

### BRIEF DESCRIPTION OF DRAWINGS

FIG. 1 is a side view of a work machine according to an embodiment.

FIG. 2 illustrates a configuration of a system according to the embodiment.

FIG. 3 is a block diagram illustrating a configuration of the system and a processing flow performed by the system.

FIG. 4 illustrates an example of an image.

FIG. 5 is a flow chart illustrating processing for switching a viewpoint of the image in accordance with a traveling state.

FIG. 6A, FIG. 6B, FIG. 6C and FIG. 6D illustrate positions of viewpoints corresponding to traveling states.

FIG. 7A, FIG. 7B and FIG. 7C illustrate positions of viewpoints corresponding to traveling states.

FIG. 8 illustrates an example of an image during forward travel.

FIG. 9 illustrates an example of an image during reverse travel.

FIG. 10 illustrates an example of an image during a right turn.

FIG. 11 illustrates an example of an image during a left turn.

FIG. 12 illustrates an example of an image during slope climbing travel.

FIG. 13 illustrates an example of an image during slope descending travel.

FIG. 14 illustrates an example of an image while shoe slip occurs.

FIG. 15 illustrates a configuration of the system according to a modified example.

### DETAILED DESCRIPTION OF EMBODIMENT(S)

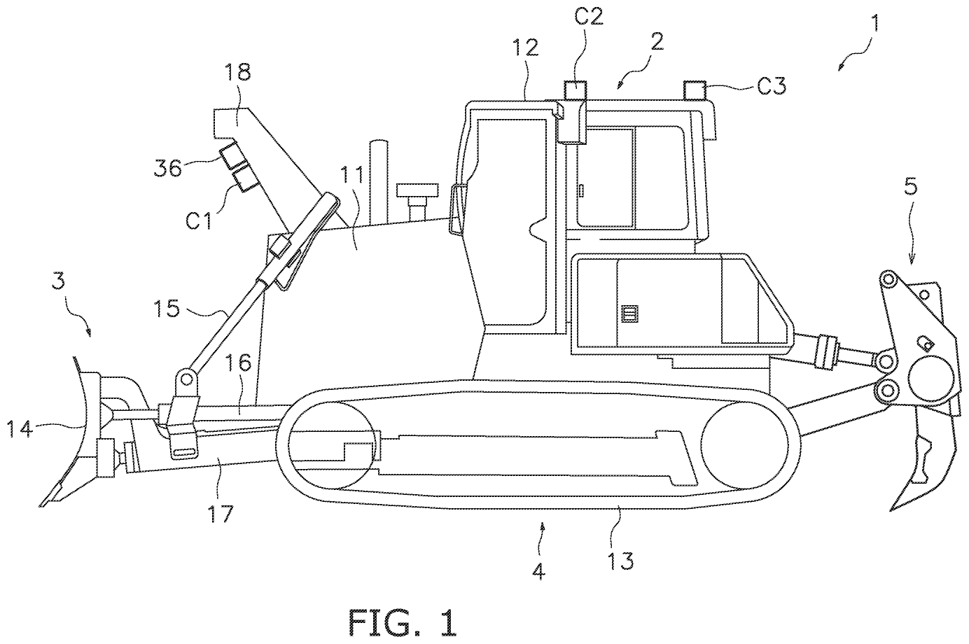

The following describes a system for a work machine according to an embodiment with reference to the drawings. FIG. 1 is a side view of a work machine 1 according to the embodiment. The work machine 1 is a bulldozer according to the present embodiment. The work machine 1 includes a vehicle body 2, a work implement 3, and a travel device 4.

The vehicle body 2 includes an engine compartment 11. An operating cabin 12 is disposed behind the engine compartment 11. A ripper device 5 is attached to a rear part of the vehicle body 2. The travel device 4 is a device for causing the work machine 1 to travel. The travel device 4 includes a pair of crawler belts 13 disposed on the left and right sides of the vehicle body 2. The work machine 1 travels due to the crawler belts 13 being driven.

The work implement 3 is disposed in front of the vehicle body 2. The work implement 3 is used for work such as excavating, earth moving, or ground leveling. The work implement 3 has a blade 14, a lift cylinder 15, a tilt cylinder 16, and an arm 17. The blade 14 is supported on the vehicle body 2 via the arm 17. The blade 14 is configured to move in the up-down direction. The lift cylinder 15 and the tilt cylinder 16 are driven by hydraulic fluid discharged from a belowmentioned hydraulic pump 22 and change the attitude of the blade 14.

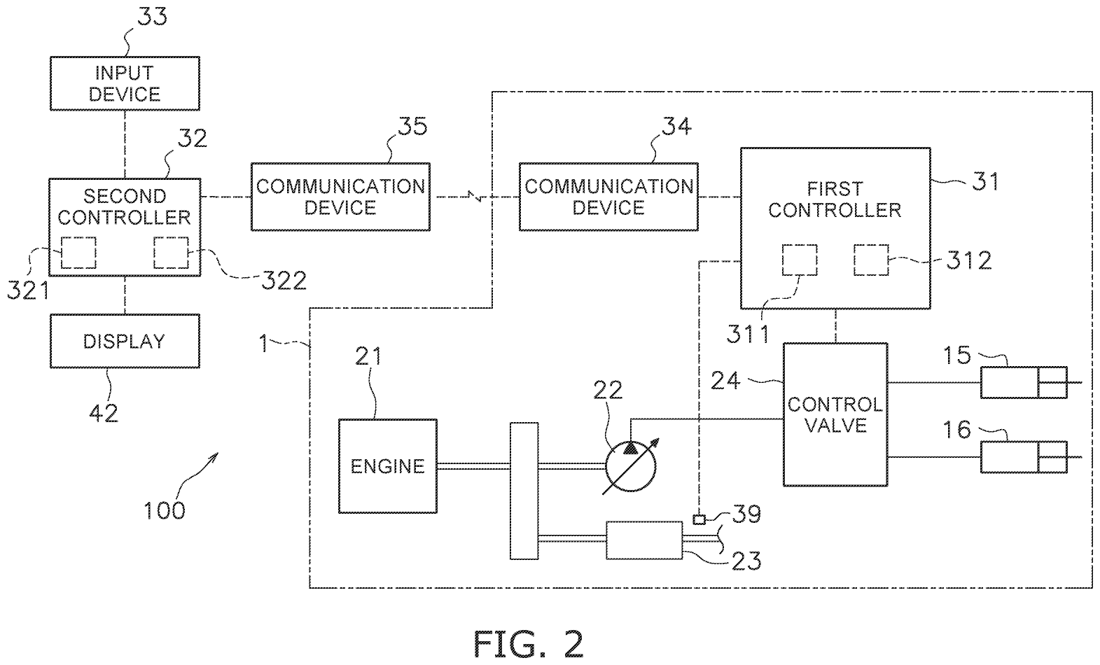

FIG. 2 is a block diagram of a configuration of a system 100 for controlling the work machine 1. As illustrated in FIG. 2, the work machine 1 includes an engine 21, the hydraulic pump 22, a power transmission device 23, and a control valve 24. The engine 21, the hydraulic pump 22, and the power transmission device 23 are disposed in the engine compartment 11. The hydraulic pump 22 is driven by the engine 21 to discharge the hydraulic fluid. The hydraulic fluid discharged from the hydraulic pump 22 is supplied to the lift cylinder 15 and the tilt cylinder 16. While only one hydraulic pump 22 is illustrated in FIG. 2, a plurality of hydraulic pumps may be provided.

The power transmission device 23 transmits the driving power of the engine 21 to the travel device 4. The power transmission device 23 may be a hydrostatic transmission (HST), for example. Alternatively, the power transmission device 23 may be, for example, a transmission having a torque converter or a plurality of speed change gears. The work machine 1 includes a vehicle speed sensor 39. The vehicle speed sensor 39 detects the vehicle speed of the work machine 1. For example, the vehicle speed sensor 39 may detect the rotation speed of an output shaft of the power transmission device 23. Alternatively, the vehicle speed sensor 39 may detect the rotation speed of a rotating element of the travel device 4.

The control valve 24 is a proportional control valve and is controlled in accordance with an input instruction signal. The control valve 24 is disposed between the hydraulic pump 22 and hydraulic actuators such as the lift cylinder 15 and the tilt cylinder 16. The control valve 24 controls the flow rate of the hydraulic fluid supplied from the hydraulic pump 22 to the lift cylinder 15 and the tilt cylinder 16. The control valve 24 may also be a pressure proportional control valve. Alternatively, the control valve 24 may be an electromagnetic proportional control valve.

The system 100 includes a first controller 31, a second controller 32, an input device 33, and communication devices 34 and 35. The first controller 31 and the communication device 34 are mounted on the work machine 1. The second controller 32, the input device 33, and the communication device 35 are disposed outside of the work machine 1. For example, the second controller 32, the input device 33, and the communication device 35 may be disposed inside a control center separate from the work site. The work machine 1 can be operated remotely through the input device 33.

The first controller 31 and the second controller 32 are programmed to control the work machine 1. The controller 31 includes a memory 311 and a processor 312. The memory 311 includes, for example, a volatile memory such as a RAM and a non-volatile memory such as a ROM. The memory 311 stores programs and data for controlling the work machine 1. The processor 312 is, for example, a central processing unit (CPU) and executes processes for controlling the work machine 1 according to a program. The first controller 31 controls the travel device 4 or the power transmission device 23 thereby causing the work machine 1 to travel. The first controller 31 causes the work implement 3 to move by actuating the control valve 24.

The second controller 32 includes a memory 321 and a processor 322. The memory 321 includes, for example, a volatile memory such as a RAM and a non-volatile memory such as a ROM. The memory 321 stores programs and data for controlling the work machine 1. The processor 322 is, for example, a central processing unit (CPU) and executes processes for controlling the work machine 1 according to a program. The second controller 32 receives operation signals from the input device 33.

The input device 33 receives operations by an operator and outputs the operation signals corresponding to the operations. The input device 33 outputs the operation signals to the second controller 32. The input device 33 includes operation elements such as an operating lever, a pedal, or a switch for operating the travel device 4 and the work implement 3. The input device 33 may include a touch panel. The travel of the work machine 1 such as forward travel or reverse travel is controlled in accordance with the operation of the input device 33. In addition, the motions of the work implement 3 such as raising or lowering is controlled in accordance with the operation of the input device 33.

The second controller 32 is configured to communicate wirelessly with the first controller 31 via the communication devices 34 and 35. The second controller 32 acquires operation data D4 from the operation signals from the input device 33 and transmits the operation data D4 to the first controller 31. The operation data D4 represents operations of the input device 33 for operating the travel device 4 and the work implement 3. The first controller 31 controls the travel device 4 and the work implement 3 in accordance with the operation data D4.

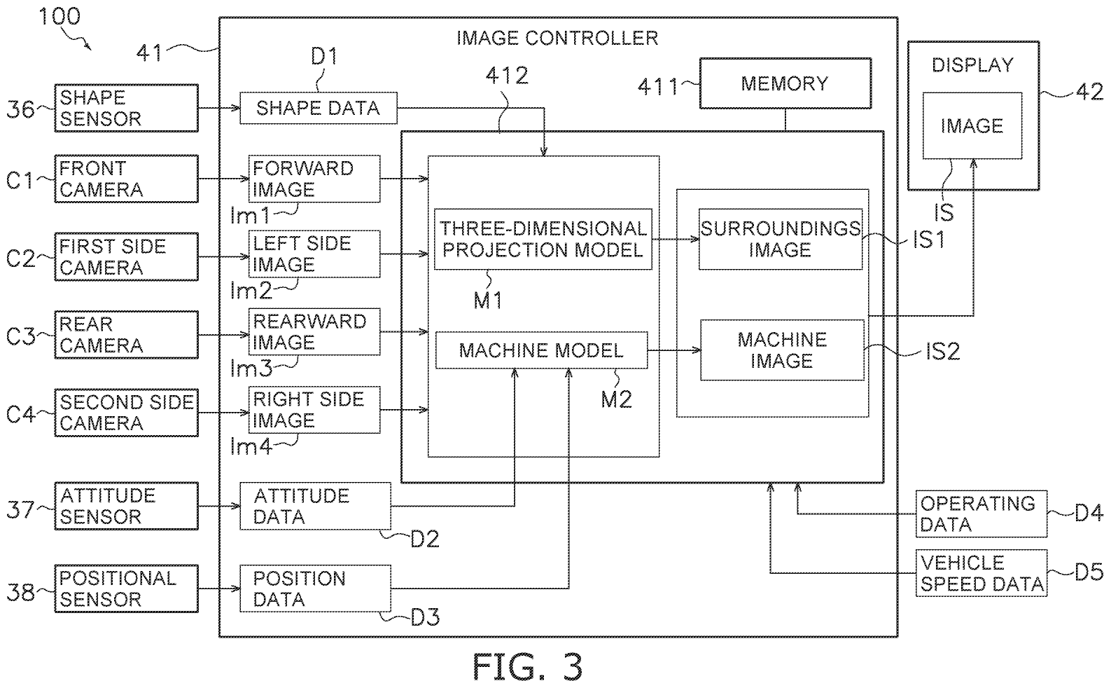

FIG. 3 is a block diagram illustrating a configuration of the system 100 for displaying the work machine 1 and surrounding images thereof, and illustrating a processing flow performed by the system. As illustrated in FIG. 3, the system 100 includes a plurality of cameras C1 to C4. The plurality of cameras C1 to C4 are attached to the vehicle body 2. The plurality of cameras C1 to C4 are fish-eye lens cameras. The angle of view of each of the plurality of cameras C1 to C4 is 180 degrees. However, the angle of view of each of the plurality of cameras C1 to C4 may be less than 180 degrees. Alternatively, the angle of view of each of the plurality of cameras C1 to C4 may be more than 180 degrees. The plurality of cameras C1 to C4 includes a front camera C1, a first side camera C2, a rear camera C3, and a second side camera C4.

As illustrated in FIG. 1, the front camera C1 is attached to a front part of the vehicle body 2. Specifically, the vehicle body 2 includes a supporting member 18 as illustrated in FIG. 1. The supporting member 18 extends upward and forward from the front part of the vehicle body 2. The front camera C1 is attached to the supporting member 18. The rear camera C3 is attached to a rear part of the vehicle body 2.

The first side camera C2 is attached to one side part of the vehicle body 2. The second side camera C4 is attached to the other side part of the vehicle body 2. In the present embodiment, the first side camera C2 is attached to a left side part of the vehicle body 2 and the second side camera C4 is attached to a right side part of the vehicle body 2. However, the first side camera C2 may be attached the right side part of the vehicle body 2 and the second side camera C4 may be attached the left side part of the vehicle body 2.

The front camera C1 acquires images in front of the vehicle body 2. The rear camera C3 acquires images to the rear of the work machine 1. The first side camera C2 acquires images on the left side of the vehicle body 2. The second side camera C4 acquires images on the right side of the vehicle body 2. The cameras C1 to C4 output image data which represents the acquired images.

The system 100 includes a shape sensor 36, an attitude sensor 37, and a positional sensor 38. The shape sensor 36 measures the three-dimensional shape of an object surrounding the work machine 1 and outputs shape data D1 which represents the three-dimensional shape. The shape sensor 36 measures the positions of a plurality of points on the object surrounding the work machine 1. The shape data D1 represents the positions of the plurality of points on the object surrounding the work machine 1. The object surrounding the work machine 1 includes, for example, the topography surrounding the work machine 1. That is, the shape data D1 represents the positions of the plurality of points on the topography surrounding the work machine 1. In particular, the shape data D1 includes the positions of the plurality of points on the topography in front of the work machine 1.

Specifically, the shape sensor 36 measures the distance from the work machine 1 of the plurality of points on the object surrounding the work machine 1. The positions of the plurality of points are derived from the distance of the plurality of points from the work machine 1. In the present embodiment, the shape sensor 36 is, for example, a LIDAR (laser imaging detection and ranging) device. The shape sensor 36 measures the distance to the measurement points by irradiating a laser and measuring the reflected light thereof.

The attitude sensor 37 detects the attitude of the work machine 1 and outputs attitude data D2 which represents the attitude. The attitude sensor 37 is, for example, an inertial measurement unit (IMU). The attitude data D2 includes the angle (pitch angle) relative to horizontal in the vehicle front-back direction and the angle (roll angle) relative to horizontal in the vehicle lateral direction. The attitude sensor 37 outputs the attitude data D2.

The positional sensor 38 is, for example, a global navigation satellite system (GNSS) receiver. The positional sensor is, for example, a receiver for a global positioning system (GPS). The positional sensor 38 receives positioning signals from a satellite and acquires position data D3 which represents position coordinates of the work machine 1 from the positioning signals. The positional sensor 38 outputs the position data D3.

The shape sensor 36 is, for example, attached to the supporting member 18. Alternatively, the shape sensor 36 may be attached to another portion of the vehicle body 2. The attitude sensor 37 and the positional sensor 38 are attached to the vehicle body 2. Alternatively, the attitude sensor 37 and the positional sensor 38 may be attached to the work implement 3.

The system 100 includes an image controller 41 and a display 42. The image controller 41 is programmed to generate an image IS which depicts the work machine 1 and the surroundings thereof and display the image IS on the display 42. The image controller 41 includes a memory 411 and a processor 412. The memory 411 includes, for example, a volatile memory such as a RAM and a non-volatile memory such as a ROM. The memory 411 stores programs and data for generating the image IS. The processor 412 is, for example, a central processing unit (CPU) and executes processes for generating the image IS and displaying the image IS on the display 42 in accordance with the programs.

The image controller 41 is communicably connected to the first controller 31 by wire or wirelessly. The image controller 41 is communicably connected to the second controller 32 by wire or wirelessly. The image controller 41 may be mounted on the work machine 1. The image controller 41 may be integrated with the first controller 31 or may be a separate item.

Alternatively, the image controller 41 may be disposed outside the work machine 1. For example, the image controller 41 may be disposed inside the control center. The image controller 41 may be integrated with the second controller 32 or may be a separate item.

The image controller 41 is communicably connected to the cameras C1 to C4 by wire or wirelessly. The image controller 41 receives the image data from the cameras C1 to C4. Alternatively, the image controller 41 may receive the image data through the first controller 31 and/or the second controller 32.

The image controller 41 is communicably connected to the shape sensor 36, the attitude sensor 37, and the positional sensor 38 by wire or wirelessly. The image controller 41 receives the shape data D1 from the shape sensor 36. The image controller 41 receives the attitude data D2 from the attitude sensor 37. The image controller 41 receives the position data D3 from the positional sensor 38. Alternatively, the image controller 41 may receive the shape data D1, the attitude data D2, and the position data D3 through the first controller 31 and/or the second controller 32.

The display 142 is a device such as a CRT, and LCD, or an OELD. However, the display 42 is not limited to the aforementioned displays and may be another type of display. The display 42 displays images based on signals from the image controller 41. The display 42 may also receive the signals from the image controller 41 through the first controller 31 and/or the second controller 32.

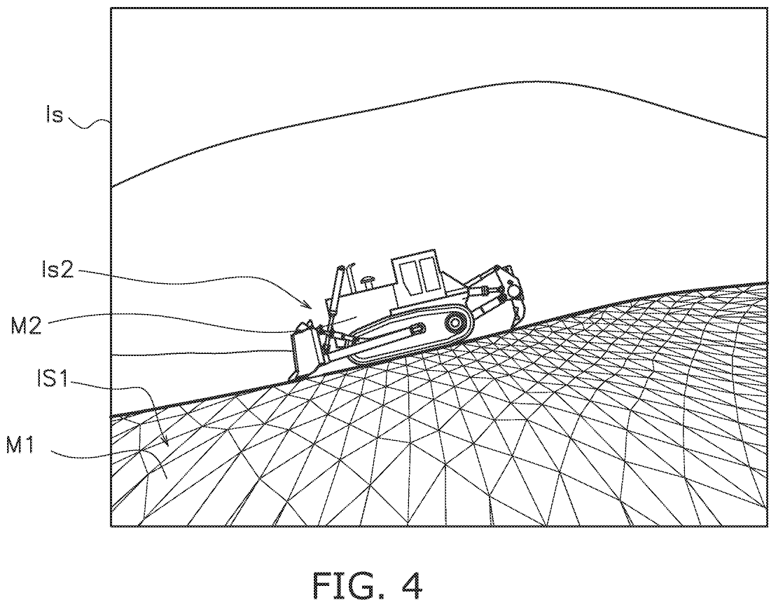

The image controller 41 generates the image IS based on the abovementioned image data, the shape data D1, the attitude data D2, and the position data D3. FIG. 4 illustrates an example of the image IS. The image IS includes the work machine 1 and an object of the surroundings thereof. The object surrounding the work machine 1 includes the topography surrounding the work machine 1. The object surrounding the work machine 1 may also include another work machine, a building, or a person. The following is an explanation of the generation of the image IS.

First, the cameras C1 to C4 capture images of the work machine 1 and the surroundings thereof. Consequently, the image controller 41 acquires a forward image Im1, a left side image Im2, a rearward image Im3, and a right side image Im4 from the cameras C1 to C4 as illustrated in FIG. 3. The forward image Im1 is an image in front of the vehicle body 2. The left side image Im2 is an image to the left of the vehicle body 2. The rearward image Im3 is an image behind the vehicle body 2. The right side image Im4 is an image to the right of the vehicle body 2.

The image controller 41 generates a surroundings image IS1 from the images Im1 to Im4 acquired by the cameras C1 to C4. The surroundings image IS1 is a composite image which represents the surroundings of the work machine 1 from a bird's-eye view. The image controller 41 generates the surroundings image IS1 by projecting the images Im1 to Im4 acquired by the cameras C1 to C4 onto a three-dimensional projection model M1 by texture mapping as illustrated in FIG. 4. The three-dimensional projection model M1 is configured with a polygon mesh which represents the shape of the object in the surroundings of the work machine 1. The image controller 41 may use a previously saved three-dimensional projection model M1. Alternatively, the image controller 41 may generate the three-dimensional projection model M1 based on the shape data D1 acquired from the shape sensor 36.

Next, the image controller 41 synthesizes a machine image IS2 which represents the work machine 1 with the surroundings image IS1. The machine image IS2 is an image which represents the work machine 1 itself in a three-dimensional manner. The image controller 41 determines the attitude of the machine image IS2 on the image IS1 from the attitude data D2. The image controller 41 determines the heading of the machine image IS2 on the image IS1 from the position data D3. The image controller 41 synthesizes the machine image IS2 in the image IS1 so that the attitude and the heading of the machine image IS2 on the image IS1 matches the actual attitude and heading of the work machine 1.

The image controller 41 may generate the machine image IS2 from the images Im1 to Im4 acquired by the cameras C1 to C4. For example, portions of the work machine 1 are included in the images acquired by the cameras C1 to C4, and the image controller 41 may generate the machine image IS2 by projecting the portions in the images onto a machine model M2. Alternatively, the machine model M2 may be a projection model having the shape of the work machine 1 and may be saved in the memory 411. The machine image IS2 may be a previously captured image or may be a previously created three-dimensional computer graphic.

The display 42 displays the image IS. The display image IS is updated in real time and displayed as a video on the display 42. Therefore, when the work machine 1 is traveling, the surroundings image IS1 and the attitude, heading, and position of the machine image IS2 in the image IS are changed and displayed in real time in accordance with the changes of the object of the surroundings and the attitude, heading and position of the work machine 1. 100561 In order to reproduce the changes in the attitude, heading and position of the work machine 1, the three-dimensional projection model M1 and the machine model M2 are rotated according to a rotating matrix which represents the changes from the attitude, heading and position when the work machine 1 started traveling. The three-dimensional projection model M1 and the machine model M2 are also translated in accordance with a translation vector. The rotation vector and the translation vector are acquired from the abovementioned attitude data D2 and the position data D3.

a. With regard to a specific method for synthesizing the image IS, for example, the method described in “Spatio-temporal bird's-eye view images using multiple fish-eye cameras” (Proceedings of the 2013 IEEE/SICE International Symposium on System Integration, pp. 753-758, 2013) or the method described in “Visualization of the surrounding environment and operational part in a 3DCG model for the teleoperation of construction machines” (Proceedings of the 2015 IEEE/SICE International Symposium on System Integration, pp. 81-87, 2015) may be used.

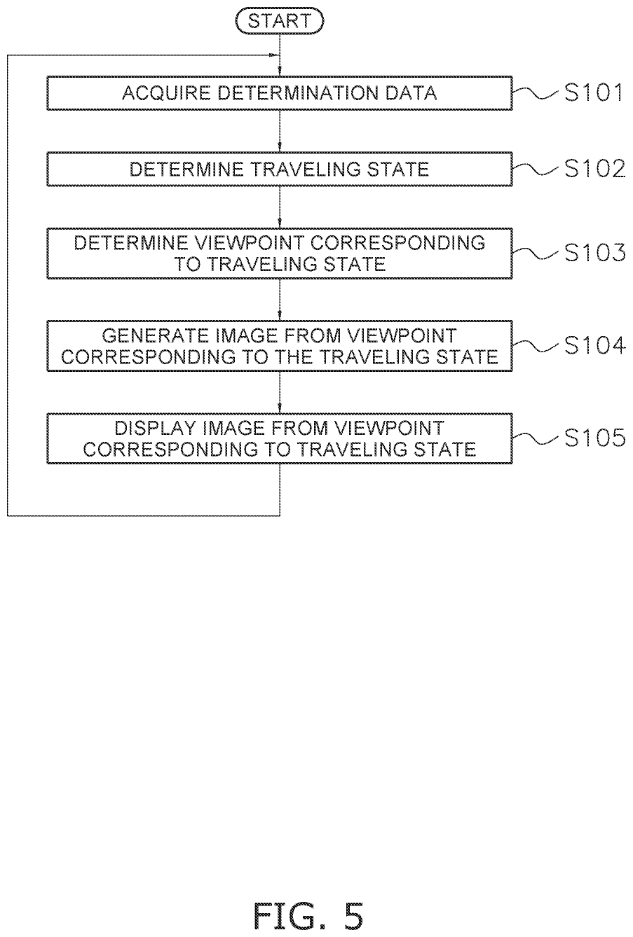

In FIG. 4, the image IS is an image of the work machine 1 and the surroundings thereof as seen from the left side. However, the image controller 41 is configured to switch the image IS to an image of the work machine 1 and the surroundings thereof as seen from a viewpoint in front, in the rear, on the right side, or above, or from an oblique viewpoint from any of the directions. In the present embodiment, the image controller 41 generates the image IS from a viewpoint corresponding to the traveling state of the work machine 1 and displays the image IS on the display 42. FIG. 5 is a flow chart illustrating processing for switching a viewpoint of the image IS in accordance with the traveling state.

In step S101 as illustrated in FIG. 5, the image controller 41 acquires determination data of the traveling state. The determination data includes the abovementioned shape data D1, the attitude data D2, the position data D3, and the operation data D4. The determination data also includes vehicle speed data D5. The image controller 41 acquires the vehicle speed data D5 indicative of the vehicle speed with a signal from the vehicle speed sensor 39. Alternatively, the vehicle speed may be calculated from the position data D3.

In step S102, the image controller 41 determines the traveling state of the work machine 1 based on the determination data. The traveling state of the work machine 1 includes the states of forward travel, reverse travel, right turn, left turn, slope climbing travel, slope descending travel, and shoe slip. The image controller 41 determines whether the current traveling state of the work machine 1 is any of the above traveling states based on the determination data.

For example, the image controller 41 determines that the traveling state of the work machine 1 is either the forward travel or reverse travel from the traveling direction of the work machine 1, the position of the work implement 3, and the vehicle speed. Specifically, when the operation data D4 indicates forward travel of the work machine 1 and raising of the work implement 3, and the vehicle speed is equal to or greater than a predetermined threshold, the image controller 41 determines that the traveling state is forward travel. When the operation data D4 indicates reverse travel of the work machine 1 and raising of the work implement 3, and the vehicle speed is equal to or greater than a predetermined threshold, the image controller 41 determines that the traveling state is reverse travel.

The image controller 41 determines that the traveling state of the work machine 1 is a right turn or a left turn from the operation data D4. Specifically, the image controller 41 determines that the traveling state of the work machine 1 is a right turn when the operation data D4 indicates a right turn of the work machine 1. Alternatively, the image controller 41 may determine that the traveling state of the work machine 1 is a right turn or a left turn from the attitude data D2. The image controller 41 may determine that the traveling state of the work machine 1 is a right turn when the attitude data D2 indicates that the azimuth of the work machine 1 has changed toward the right. Alternatively, the image controller 41 may determine that the traveling state of the work machine 1 is a right turn or a left turn from the position data D3. When the position data D3 indicates that the vector of the traveling direction of the work machine 1 has changed toward the right, the image controller 41 may determine that the traveling state of the work machine 1 is a right turn. With regard to the determination of a left turn, the determination of the left turn is made in the same way except for the left-right symmetry.

The image controller 41 determines that the traveling state of the work machine 1 is slope climbing travel or slope descending travel from the operation data D4 and the shape data D1. Specifically, when the operation data D4 indicates that the work machine 1 is traveling forward and the shape data D1 indicates that the topography in front of the work machine 1 is a climbing slope, the image controller 41 determines that the traveling state of the work machine 1 is slope climbing travel. When the operation data D4 indicates that the work machine 1 is traveling forward and the shape data D1 indicates that the topography in front of the work machine 1 is a descending slope, the image controller 41 determines that the traveling state of the work machine 1 is slope descending travel.

The image controller 41 calculates a ratio between the actual vehicle speed and a theoretical vehicle speed as a shoe slip rate. The actual vehicle speed is the vehicle speed represented by the vehicle speed data D5. The theoretical vehicle speed is a vehicle speed derived from the position data D3. The image controller 41 compares the shoe slip rate and a predetermined threshold to thereby determine whether the traveling state of the work machine 1 is the shoe slip state.

In step S103, the image controller 41 determines the viewpoint that corresponds to the traveling state. The image controller 41 stores data with which the position of the viewpoint corresponding to the traveling state is defined. The image controller 41 refers to the data and determines the viewpoint corresponding to the traveling state.

In step S104, the image controller 41 generates the image IS from the viewpoint VP corresponding to the traveling state. In step S105, the image controller 41 displays the image IS from the viewpoint VP that corresponds to the traveling state on the display 42.

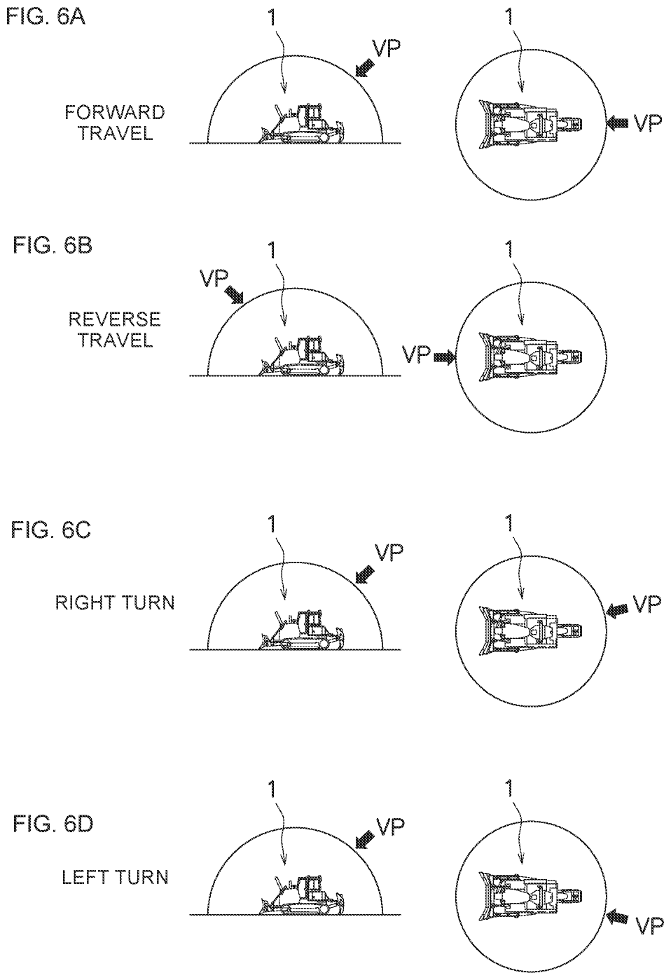

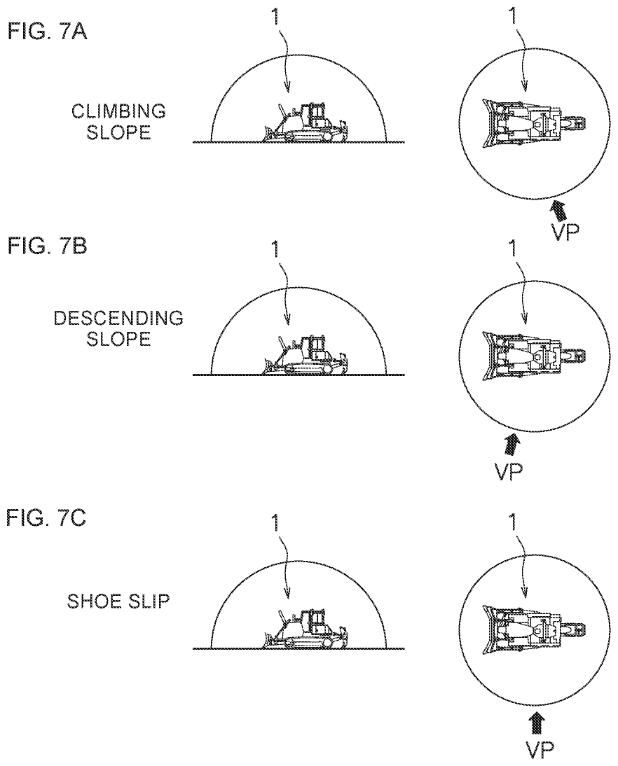

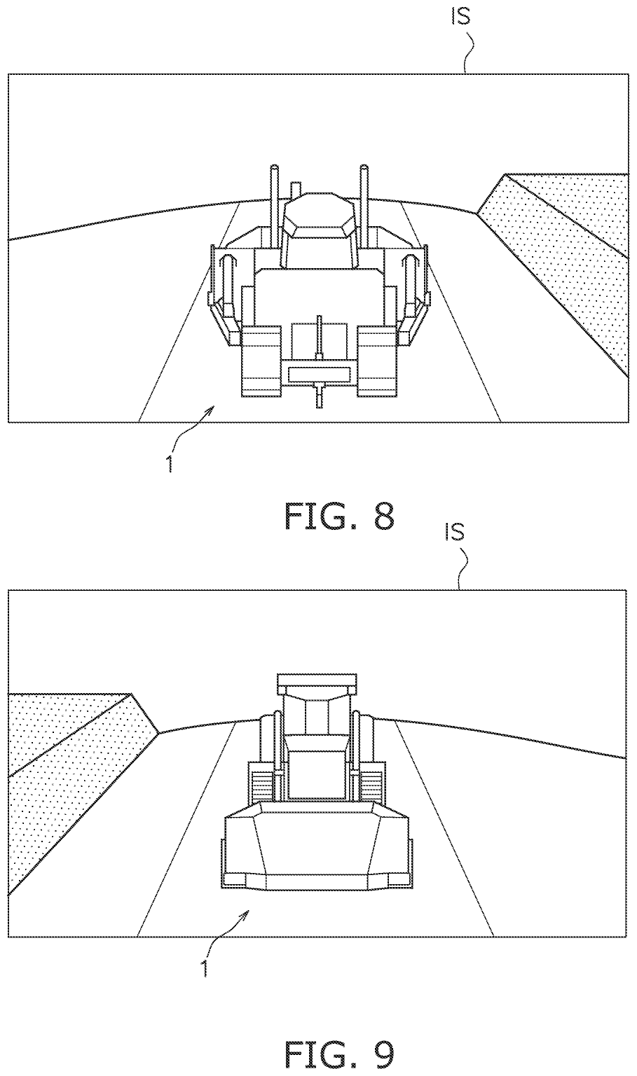

FIGS. 6A-6D and FIGS. 7A-7C illustrate positions of the viewpoint VP corresponding to the traveling state. As illustrated in FIG. 6A, the image controller 41 determines the viewpoint VP of the image IS to be at a position to the rear and above the work machine 1 when the traveling state is forward travel. Consequently, the image controller 41 generates the image IS from the rearward and upward viewpoint VP of the work machine 1 and displays the image IS on the display 42 as illustrated in FIG. 8. The image IS during forward travel depicts the entirety of the work machine 1 and the surroundings of the work machine 1. The image controller 41 determines the viewpoint VP and the position of the work machine 1 so that the front of the work machine 1 is wider than the rear in the image IS during forward travel.

As illustrated in FIG. 6B, the image controller 41 determines the viewpoint VP of the image IS to be at a position in front and above the work machine 1 when the traveling state is reverse travel. Consequently, the image controller 41 generates the image IS from the forward and upward viewpoint VP of the work machine 1 and displays the image IS on the display 42 as illustrated in FIG. 9. The image IS during reverse travel depicts the entirety of the work machine 1 and the surroundings of the work machine 1. The image controller 41 determines the viewpoint VP and the position of the work machine 1 so that the rear of the work machine 1 is wider than the front in the image IS during reverse travel.

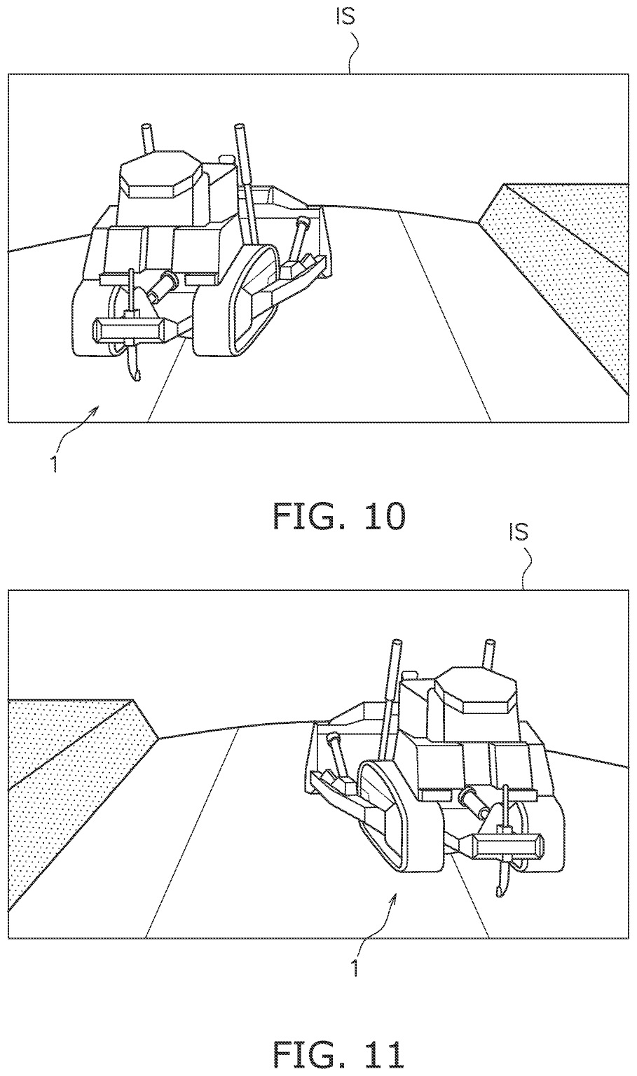

As illustrated in FIG. 6C, the image controller 41 determines the viewpoint VP of the image IS to be at a position further to the right than straight behind the work machine 1 and above the work machine 1 when the traveling state is a right turn. Consequently, the image controller 41 generates the image IS from the viewpoint VP in which the right side portion of the work machine 1 can be seen and displays the image IS on the display 42 as illustrated in FIG. 10. The image IS during a right turn depicts the entirety of the work machine 1 and the surroundings of the work machine 1. The image controller 41 determines the viewpoint VP and the position of the work machine 1 so that the right side of the work machine 1 is wider than the left side in the image IS during a right turn.

As illustrated in FIG. 6D, the image controller 41 determines the viewpoint VP of the image IS to be at a position further to the left than straight behind the work machine 1 and above the work machine 1 when the traveling state is a left turn. Consequently, the image controller 41 generates the image IS from the viewpoint VP in which the left side portion of the work machine 1 can be seen and displays the image IS on the display 42 as illustrated in FIG. 11. The image IS during a left turn depicts the entirety of the work machine 1 and the surroundings of the work machine 1. The image controller 41 determines the viewpoint VP and the position of the work machine 1 so that the left side of the work machine 1 is wider than the right side in the image IS during a left turn.

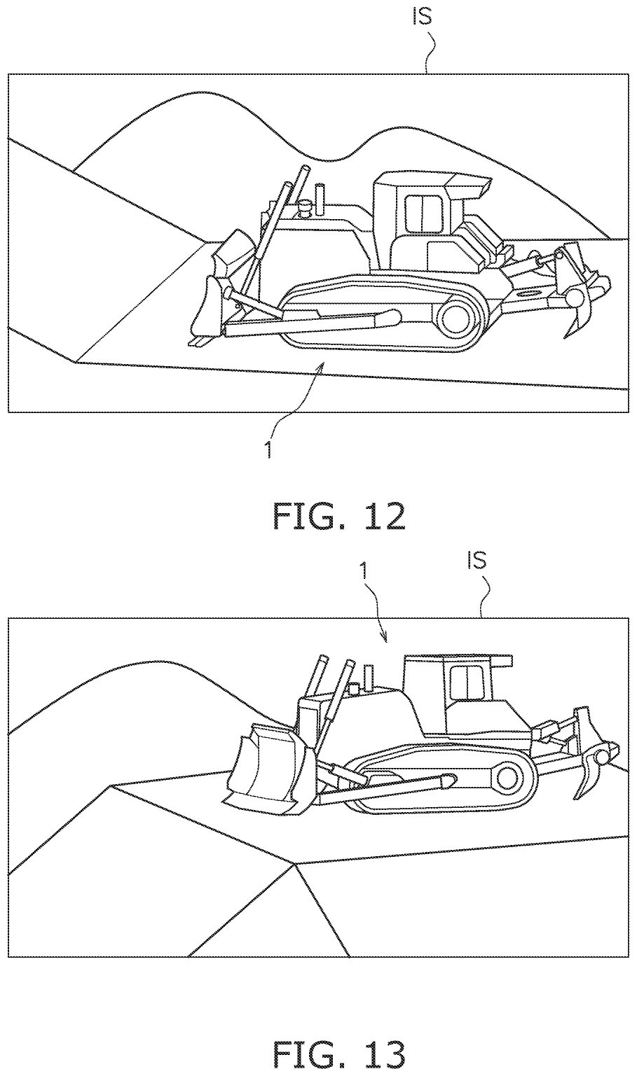

As illustrated in FIG. 7A, the image controller 41 determines the viewpoint VP of the image IS to be at a position further toward the rear than lateral to the work machine 1 when the traveling state is slope climbing travel. Consequently, the image controller 41 generates the image IS from the viewpoint VP further toward the rear than lateral to the work machine 1 and displays the image IS on the display 42 as illustrated in FIG. 12. The image IS during slope climbing travel depicts the entirety of the work machine 1 and the surroundings of the work machine 1. The image controller 41 determines the viewpoint VP and the position of the work machine 1 so that the front of the work machine 1 is wider than the rear in the image IS during slope climbing travel. The image controller 41 determines the viewpoint VP and the position of the work machine 1 so that the size of the work machine 1 is about half of the lateral width of the image IS in the image IS during slope climbing travel.

As illustrated in FIG. 7B, the image controller 41 determines the viewpoint VP of the image IS to be at a position further toward the front than lateral to the work machine 1 when the traveling state is slope descending travel. Consequently, the image controller 41 generates the image IS further toward the front than lateral to the work machine 1 and displays the image IS on the display 42 as illustrated in FIG. 13. The image IS during slope descending travel depicts the entirety of the work machine 1 and the surroundings of the work machine 1. The image controller 41 determines the viewpoint VP and the position of the work machine 1 so that the front of the work machine 1 is wider than the rear in the image IS during slope descending travel. The image controller 41 determines the viewpoint VP and the position of the work machine 1 so that the size of the work machine 1 is about half of the lateral width of the image IS in the image IS during slope descending travel.

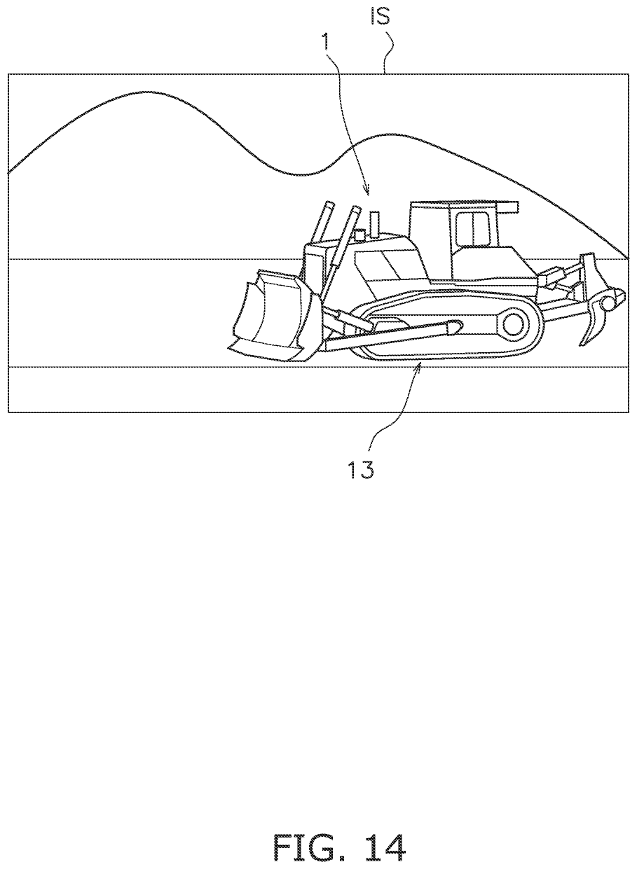

As illustrated in FIG. 7C, the image controller 41 determines the viewpoint VP of the image IS to be at a position to the side of the crawler belt 13 when the traveling state is the shoe slip state. Specifically, when the left side crawler belt 13 is in the shoe slip state, the image controller 41 determines the viewpoint VP of the image IS to be at a position to the left of the left side crawler belt 13. Consequently, the image controller 41 generates the image IS from the leftward viewpoint VP of the left side crawler belt 13 and displays the image IS on the display 42 as illustrated in FIG. 14.

Specifically, when the right side crawler belt 13 is in the shoe slip state, the image controller 41 determines the viewpoint VP of the image IS to be at a position to the right of the right side crawler belt 13. Consequently, the image controller 41 generates the image IS from the rightward viewpoint VP of the right side crawler belt 13 and displays the image IS on the display 42 as illustrated in FIG. 14. The image controller 41 determines the viewpoint VP and the position of the work machine 1 so that the front of the work machine 1 is wider than the rear in the image IS during the shoe slip state. The image controller 41 determines the viewpoint VP and the position of the work machine 1 so that the size of the work machine 1 is about half of the lateral width of the image IS in the image IS during the shoe slip state.

The image controller 41 repeatedly executes the above steps S101 to S105. Therefore, when the traveling state of the work machine 1 changes, the viewpoint VP is changed in accordance with the changes of the traveling state in step S103. Then in step S104, the image IS is generated from the viewpoint VP that has been changed in accordance with the change of the traveling state and the changed image IS is displayed on the display 42 in step S105.

The traveling state of the work machine 1 is acquired in the system 100 according to the present embodiment explained above. The image IS from a viewpoint corresponding to the traveling state is displayed on the display 42. As a result, the user is able to easily use the image IS from a viewpoint corresponding to the traveling state of the work machine 1. 11:10761 The image controller 41 generates the image IS from each of the different viewpoints VP when the traveling state is forward travel, reverse travel, a right turn, or a left turn. Specifically, when the traveling state is forward travel, the image IS from the viewpoint VP to the rear of the work machine 1 is displayed on the display 42. As a result, it is easy to see forward of the work machine 1. When the traveling state is reverse travel, the image IS from the viewpoint VP in front of the work machine 1 is displayed on the display 42. As a result, it is easy to see to the rear of the work machine 1.

When the traveling state is a right turn, the image IS from the viewpoint VP further to the right than straight behind is displayed on the display 42 so that the right side portion of the work machine 1 can be seen. As a result, it is easy to ascertain that the work machine 1 is turning right from the image IS.

When the traveling slate is a left turn, the image IS from the viewpoint VP further to the left than straight behind is displayed on the display 42 so that the left side portion of the work machine 1 can be seen. As a result, it is easy to ascertain that the work machine 1 is turning left from the image IS.

The image controller 41 generates the image IS from each of the different viewpoints VP when the traveling state is slope climbing travel or slope descending travel. Specifically, when the traveling state is slope climbing travel, the image IS from the viewpoint VP further to the rear than lateral to the work machine 1 is displayed on the display 42. As a result, it is easy to ascertain the rising slope of the topography from the image IS. When the traveling state is slope descending travel, the image IS from the viewpoint VP further to the front than lateral to the work machine 1 is displayed on the display 42. As a result, it is easy to ascertain the descending slope of the topography from the image IS.

While an embodiment of the present disclosure has been described above, the present invention is not limited to the embodiment and the following modifications may be made within the scope of the present invention. For example, the work machine is not limited to a bulldozer and may be another type of work machine such as a wheel loader or a hydraulic excavator.

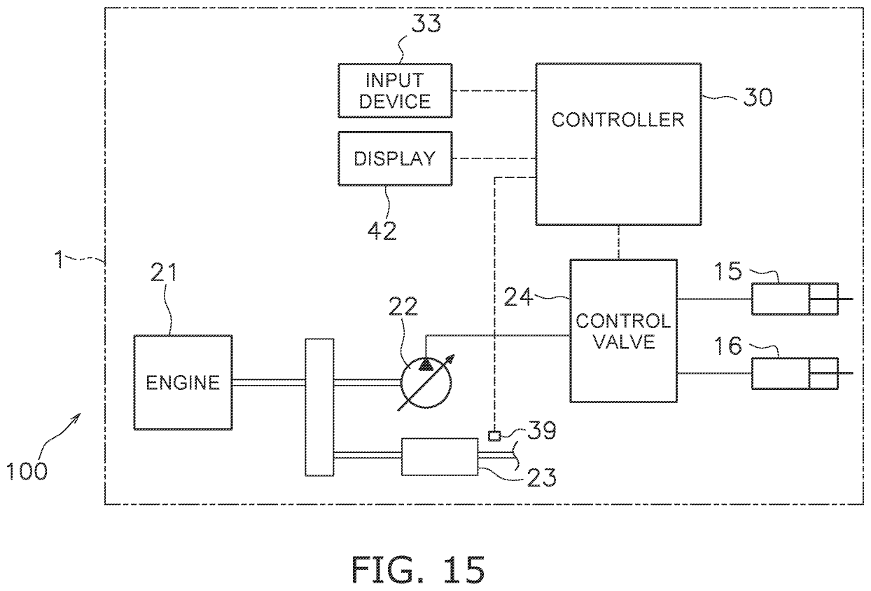

The work machine 1 may be operated from inside the operating cabin and not remotely. FIG. 15 illustrates a configuration of the work machine 1 according to a modified example. As illustrated in FIG. 15, the work machine 1 may include a controller 30 mounted to the work machine 1. The controller 30 has the same configuration as the abovementioned first controller 31 or the second controller 32 and therefore a detailed explanation will be omitted. The controller 30 may execute the abovementioned processes from step S101 to step S105. In this case, the input device 33 may be disposed inside the operating cabin.

The first controller 31 is not limited to one unit and may be divided into a plurality of controllers. The second controller 32 is not limited to one unit and may be divided into a plurality of controllers. The controller 30 is not limited to one unit and may be divided into a plurality of controllers.

The abovementioned processes of step S101 to step S105 may be executed by another controller instead of the image controller 41. For example, the processes of step S101 to step S105 may be executed by the first controller 31 or the second controller 32.

The number of the cameras is not limited to four and may be three or less or five or more. The cameras are not limited to fish-eye lens cameras and may be a different type of camera. The dispositions of the cameras are not limited to the dispositions indicated in the above embodiment and may be disposed differently.

The attitude sensor 37 is not limited to an IMU and may be another sensor. The positional sensor 38 is not limited to a GNSS receiver and may be another sensor. The shape sensor 36 is not limited to a LIDAR device and may be another measuring device such as a radar device.

The types of the traveling states are not limited to the ones of the above embodiment and may be changed. For example, a portion of the types of traveling slates may be omitted. Alternatively, another type of traveling state may be added. The determination methods of the traveling states are not limited to the ones of the above embodiment and may be changed. For example, the traveling states may be determined based on signals from a sensor for detecting the motions of the work implement 3. The positions of the viewpoint VP in each of the traveling states are not limited to the positions of the above embodiment and may be changed.

According to the present disclosure, the user is able to easily use an image from a viewpoint corresponding to the traveling state of the work machine.

1. A system comprising:
a work machine including a work implement;
a plurality of cameras that capture images indicative of surroundings of the work machine;
a processor configured to
acquire image data indicative of the images captured by the plurality of cameras,
acquire a traveling state of the work machine,
synthesize the images, and
generate an image from a viewpoint corresponding to the traveling state; and
a display that displays the image from the viewpoint corresponding to the traveling state based on a signal from the processor.

2. The system according to claim 1, wherein the traveling state includes forward travel and turning, and
the processor is configured to generate the image from a different viewpoint when the traveling state is forward travel and when the traveling state is turning.

3. The system according to claim 1, wherein
the traveling state includes reverse travel and turning, and
the processor is configured to generate the image from a different viewpoint when the traveling state is reverse travel and when the traveling state is turning.

4. The system according to claim 1, wherein
the traveling state includes forward travel and reverse travel, and
the processor is configured to generate the image from a different viewpoint when the traveling state is forward travel and when the traveling state is reverse travel.

5. The system according to claim 2, wherein
the processor is configured to generate the image from a viewpoint in which a side portion of the work machine can be seen when the traveling state is turning.

6. The work machine according to claim 2, wherein
the processor is configured to generate the image from a viewpoint behind the work machine when the traveling state is forward travel.

7. The system according to claim 3, wherein
the processor is configured to generate the image from a viewpoint in front of the work machine when the traveling state is reverse travel.

8. The system according to claim 1, wherein
the processor is configured to generate an image depicting the entire work machine and the surroundings of the work machine.

9. The system according to claim 1, wherein
the traveling state includes slope climbing travel, and
the processor is configured to generate the image from a viewpoint further to a rear than lateral to the work machine when the traveling state is slope climbing travel.

10. The system according to claim 1, wherein
the traveling state includes slope descending travel, and
the processor is configured to generate the image from a viewpoint further to a front than lateral to the work machine when the traveling state is slope descending travel.

11. The system according to claim 1, wherein
the work machine includes a crawler belt,
the traveling state includes a shoe slip state of the crawler belt, and
the processor is configured to generate the image from a viewpoint to a side of the crawler belt when the traveling state is the shoe slip state.

12. A method executed by a processor for displaying, on a display, surroundings of a work machine including a work implement, the method comprising:
capturing images indicative of the surroundings of the work machine with a plurality of cameras;
acquiring image data indicative of the images captured by the plurality of cameras;
acquiring a traveling state of the work machine;
synthesizing the images and generating an image from a viewpoint corresponding to the traveling state; and
displaying the image from the viewpoint corresponding to the traveling state on the display.

13. The method as in claim 12, wherein
the traveling state includes forward travel and turning, and
the generating the image includes generating the image from a different viewpoint when the traveling state is forward travel and when the traveling state is turning.

14. The method according to claim 12, wherein
the traveling state includes reverse travel and turning, and
the generating the image includes generating the image from a different viewpoint when the traveling state is reverse travel and when the traveling state is turning.

15. The method according to claim 12, wherein
the traveling state includes forward travel and reverse travel, and
the generating the image includes generating the image from a different viewpoint when the traveling state is forward travel and when the traveling state is reverse travel.

16. The method according to claim 13, wherein
the generating the image includes generating the image from a viewpoint in which a side portion of the work machine can be seen when the traveling state is turning.

17. The method according to claim 13, wherein
the generating the image includes generating the image from a viewpoint behind the work machine when the traveling state is forward travel.

18. The method according to claim 14, further comprising:
generating the image from a viewpoint in front of the work machine when the traveling state is reverse travel.

19. The method according to claim 12, wherein
the traveling state includes slope climbing travel, and
the generating the image includes generating the image from a viewpoint further to a rear than lateral to the work machine when the traveling state is the slope climbing travel.

20. A system comprising:
a processor configured to
acquire image data indicative of images depicting surroundings of a work machine,
acquire a traveling state of the work machine,
synthesize the images, and
generate an image from a viewpoint corresponding to the traveling state; and
a display that displays the image from the viewpoint corresponding to the traveling state based on a signal from the processor.
